(19) United States
(12) Patent Application Publication
(10) Pub. No.: US 2014/0119846 A1
(43) Pub. Date: May 1, 2014

(54) WRENCH-BASED TAP AND DIE HOLDERS

(71) Applicant: Bruce O. Larsson, Dudley, MA (US)

(72) Inventor: Bruce O. Larsson, Dudley, MA (US)

(21) Appl. No.: 14/065,413

(22) Filed: Oct. 28, 2013

Related U.S. Application Data
(60) Provisional application No. 61/719,330, filed on Oct. 26, 2012.
(60) Provisional application No. 61/802,227, filed on Mar. 15, 2013.
(60) Provisional application No. 61/807,718, filed on Apr. 2, 2013.

(51) Int. Cl. B23G 1/02

(52) U.S. Cl. CPC B23G 1/02
USPC 408/222

(57) ABSTRACT

A threading tool, such as a tap or die holder, is configured to be driven by a generic wrench. The tool is provided with a wrench-engageable surface, such as a faceted cylindrical surface, or a cylinder with a polyhedral cross-section perpendicular to its axis. A outwardly extending peripheral flange, downward from the wrench-engageable surface, contacts and allows an open-backed wrench to exert downward force on the tool. A inwardly extending peripheral groove, downward from the wrench-engageable surface, allows a wrench to insert a holding device into the profile of the tool to hold the wrench and tool together. The holder may have a collet that activates the holding function by moving along the axis of the holder, but the collet is prevented from rotating about the axis of the holder. The collet may have a wrench-engageable surface. A collar, threaded to the holder, moves the collet.

### CROSS-REFERENCE TO RELATED APPLICATIONS

This application claims the benefit under 35 U.S.C. §119(e) of U.S. Provisional Application No. 61/71,330 filed 2012 Oct. 26, U.S. Provisional Application No. 61/802,227 filed 2013 Mar. 15, and U.S. Provisional Application No. 61/807,718 filed 2013 Apr. 2, all of which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves wrench-based tap and die holders.

### BACKGROUND OF THE INVENTION

Prior systems for driving tap and die holders generally were limited to specialized driver tools that were characterized by inefficiency, a proneness to awkwardness, an inability to adapt to the unusual application geometries that are frequently found in non-industrial contexts, and difficulty in use.

These and other difficulties experienced with the prior art devices have been obviated in a novel manner by the present invention.

It is, therefore, an outstanding object of some embodiments of the present invention to provide a system for driving taps and dies that operates in an efficient and effective manner.

Another object of some embodiments of the present invention is to provide a system for driving taps and dies that operates efficiently in a vast array of situations.

A further object of some embodiments of present invention is to provide a system a system for driving taps and dies that takes full advantage of the numerous wrench systems available in the marketplace.

It is another object of some embodiments of the present invention is to provide a system for driving taps and dies that is economical.

It is a further object of some embodiments of the present invention to provide a system for driving taps and dies that provides driving geometries not previously available.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a threading tool, such as a tap or die holder. It is configured to be driven by a generic wrench. The tool is provided with a wrench-engageable surface, such as a faceted cylindrical surface, or a cylinder with a polyhedral cross-section perpendicular to its axis. A outwardly extending peripheral flange, downward from the wrench-engageable surface, contacts and allows an open-backed wrench to exert downward force on the tool. A inwardly extending peripheral groove, downward from the wrench-engageable surface, allows a wrench to insert a holding device into the profile of the tool to hold the wrench and tool together. The holder may have a collet that activates the holding function by moving along the axis of the holder, but the collet is prevented from rotating about the axis of the holder. The collet may have a wrench-engageable surface. A collar, threaded to the holder, moves the collet.

### BRIEF DESCRIPTION OF THE DRAWINGS

The character of the invention, however, may best be understood by reference to one of its structural forms, as illustrated by the accompanying drawings, in which:

FIG. 1 shows the overall concept of the tap holder embodying the principles of the present invention.

FIG. 2 shows an additional view of the structure shown in FIG. 1.

FIG. 3 shows, in top view, how the device shown in FIG. 1 can be driven by a crescent wrench.

FIG. 4 shows an elevation view of the embodiment shown in FIG. 3.

FIG. 5 shows an overall view of a die holder embodying the principles of the present invention.

FIG. 6 shows a top view of a die holder especially useful for putting threads on a long shaft.

FIG. 7 is a side view of the die holder.

FIG. 8 is a side view of the die.

FIG. 9 is a bottom view of the die holder with a holding screw.

FIG. 10 is a top view of the die.

FIG. 11 shows a top view of a version of the die holder specially designed to be driven by either a crescent wrench or a socket drive.

FIG. 12 is the side view of the die holder, with a cutting oil injection hole on the side.

FIG. 13 is a side view of the hexagonal die.

FIG. 14 is a bottom view of the die holder showing that hexagonal opening in which the die is placed and then fastened by the screw.

FIG. 15 is a top view of the hexagonal die.

FIG. 16 shows a converter that fits over the hexagonal projection.

FIG. 17 is a top view of the die holder showing the hexagonal projection.

FIG. 18 is a side view of the die holder with the wrench engageable hexagonal projection on the top.

FIG. 19 is a top view of an elongated die holder.

FIG. 20 is an elevation view of an elongated die holder.

FIG. 21 is a bottom view of an elongated die holder.

FIG. 22 shows a plan view of a typical die which can have a circular circumference.

FIG. 23 is a top view of an adapter for circular dies.

FIG. 24 is a elevation view of an adapter for circular dies.

FIG. 25 is a bottom view of an adapter for circular dies.

FIG. 26 shows a plan view of a typical die with a hexagonal circumference.

FIG. 27 is a top view of an adapter for hexagonal dies.

FIG. 28 is a elevation view of an adapter for hexagonal dies.

FIG. 29 is a bottom view of an adapter for hexagonal dies.

FIG. 30 shows a unlocked view of a new kind of wrench.

FIG. 31 shows a locked view of a new kind of wrench.

FIG. 32 shows a plan view of a typical die which can have a circular circumference.

FIG. 33 is a top view of a grooved adapter for circular dies.

FIG. 34 is a elevation view of a grooved adapter for circular dies.

FIG. 35 is a bottom view of a grooved adapter for circular dies.

FIG. 36 shows a plan view of a typical die with a hexagonal circumference.

FIG. 37 is a top view of a grooved adapter for hexagonal dies.

FIG. 38 is a elevation view of a grooved adapter for hexagonal dies.

FIG. 39 is a bottom view of a gro

FIG. 40 shows a sectional view taken along line 40-40 of FIG. 34.

FIG. 41 shows a sectional view taken along line 41-41 of FIG. 33 and along line 41-41 of FIG. 38.

FIG. 42 shows a cross-sectional view taken along line 42-42 of FIG. 34, and along line 42-42 of FIG. 38.

FIG. 43 shows an unlocked position of the wrench as it holds the cross-sectional representation of FIG. 40.

FIG. 44 show the locked position of the wrench as it holds the cross-sectional representation of FIG. 40.

FIG. 45 shows the wrench engageable element locked in the wrench.

FIG. 46 shows the wrenching digital element not locked in the wrench.

FIG. 47 shows a plan view of a circular die.

FIG. 48 shows a plan view of a circular die holder shown in FIG. 49.

FIG. 49 shows a front elevation view of the circular die holder shown in FIG. 48.

FIG. 50 shows a bottom view of the circular die holder shown in FIG. 49.

FIG. 51 shows a plan view of a hexagonal die.

FIG. 52 shows a plan view of a deep-well socket shown in FIG. 53.

FIG. 53 shows a front elevation view of the deep-well socket shown in FIG. 52.

FIG. 54 shows a bottom view of the deep-well socket shown in FIG. 53.

FIG. 55 shows a plan view, in section as viewed along the line 55-55 of the deep-well socket shown in FIG. 53.

FIG. 56 shows a front elevation view, in section as viewed along the line 56-56 of the deep-well socket shown in FIG. 52.

FIG. 57 shows a bottom view, in section as viewed along the line 57-57 of the deep-well socket shown in FIG. 53.

FIG. 58 shows a front elevation view, in section as viewed along the line 56-56 of the deep-well socket shown in FIG. 52

FIG. 59 shows the locked position of the new wrench.

FIG. 60 shows the unlocked position of the new wrench.

FIG. 61 shows the shank of the holder.

FIG. 62, shows that the upper end of the collet has a peripheral outwardly-directed flange.

FIG. 63 shows that the lower end of the collar has peripheral inwardly directed flange.

FIG. 64 shows the assembly of the tap holder shank, the collet, and the surrounding collar, engaging the threads of the shank.

FIG. 65 shows that the collar has been threaded upward on the threaded flange of the shank.

FIG. 66 shows another aspect of the invention.

FIG. 67 shows another aspect of the invention.

FIG. 68 shows another aspect of the invention.

FIG. 69 shows another aspect of the invention.

FIG. 70 shows another aspect of the invention.

FIG. 71 shows another aspect of the invention.

FIG. 72 shows another aspect of the invention.

FIG. 73 shows another aspect of the invention.

FIG. 74 shows another aspect of the invention.

FIG. 75 shows another aspect of the invention.

FIG. 76 shows another aspect of the invention.

FIG. 77 shows another aspect of the invention.

FIG. 78 shows another aspect of the invention.

FIG. 79 shows another aspect of the invention.

FIG. 80 shows another aspect of the invention.

FIG. 81 shows another aspect of the invention.

FIG. 82 shows another aspect of the invention.

FIG. 83 shows another aspect of the invention.

FIG. 84 shows another aspect of the invention.

FIG. 85 shows another aspect of the invention.

FIG. 86 shows another aspect of the invention.

FIG. 87 shows another aspect of the invention.

FIG. 88 shows another aspect of the invention.

FIG. 89 shows another aspect of the invention.

FIG. 90 shows another aspect of the invention.

FIG. 91 shows another aspect of the invention.

FIG. 92 shows another aspect of the invention.

FIG. 92 shows another aspect of the invention.

FIG. 94 shows another aspect of the invention.

FIG. 95 shows another aspect of the invention.

FIG. 96 shows another aspect of the invention.

FIG. 97 shows another aspect of the invention.

FIG. 98 shows another aspect of the invention.

FIG. 99 shows another aspect of the invention.

FIG. 100 shows another aspect of the invention.

FIG. 101 shows another aspect of the invention.

FIG. 102 shows another aspect of the invention.

### DETAILED DESCRIPTION OF THE INVENTION

TAP HOLDERS: There are hundreds of tap holders currently on the market. The majority of these are variants of the sliding T-Handle design. In all cases, the T-Handle or drive mechanism is permanently attached to the tool. This limit's the tool's performance in tight, close quarters applications like those found in the automotive trades.

The present invention has no drive mechanism, it is simply a tap holder, with an internal (square drive) and an external (hex drive) wrenchable surface.

This allows the user to configure or adapt the tool to any of the specialty wrenches and attachments that are now being used to overcome obstructions that arise in real world applications.

The few wrench-based tap holders that exist feature an internal (square drive) wrenchable surface only. Although more versatile than the T-Handle, they are limited to socket based attachments. The present invention has both square drive and hex drive capabilities and uses the industry standard adjustable collet style system to secure the tap.

This simple two piece design provides more versatility than all of the more costly and complex tap holders now available.

DIE HOLDERS: There are two types of threading dies; round dies and hex dies. Round dies require holders specific to their use. The more popular hex dies also have dedicated holders, but can also be used with wrenches and sockets.

The main drawback to threading rod with wrench based dies is the inability to secure the die to the wrench. This becomes a problem when downward pressure and cutting oil is applied to start the cut. The present invention die holder is essentially a special purpose-built deep-well socket with an internal (square drive) and an external (hex drive) wrenchable surface at the top. The bottom features an internal shoulder and external set screw to support and secure the die when downward pressure is applied. This is an asset when working in the confined spaces or awkward positions that often arise in the automotive trades.

It also features two adapter heads, one for round dies, one for hexagonal dies. The round die adapter is mainly a convenience that can be used to convert the main body to round dies. Although both can be secured to the main holder, they are really independent units designed for longer or unlimited threading applications. Like the main body, both have an internal shoulder and external setscrew to support and secure the die. However, these only have one outer wrenchable surface (hex drive) in order to let longer rods pass through.

As with the tap holder, each unit is a simple two piece design consisting of nothing more than a wrench based body and set screw that provides more versatility than the die holders now available.

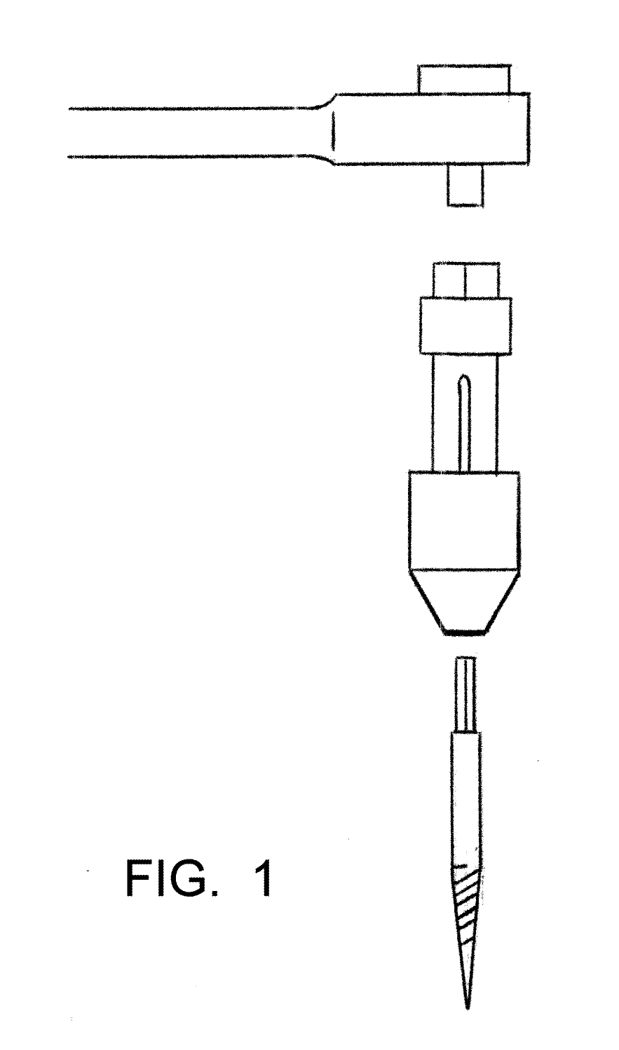

FIG. 1 shows the overall concept of the tap holder embodying the principles of the present invention. The center portion is a version of the new device. The bottom of the center portion is a conventional tap holder wrench. The upper portion provides a wrenching engageable structure with an external hexagonal projection and an outwardly directed flange at the bottom of the hexagonal projection to allow a wrench engaging the hexagonal projection to port downward pressure on the tap holder and therefore on the tap being driven. Within the hexagonal structure is a socket wrench engageable bore, not shown. FIG. 1 shows how the socket wrench if lowered into the bore, could be used to drive the tap.

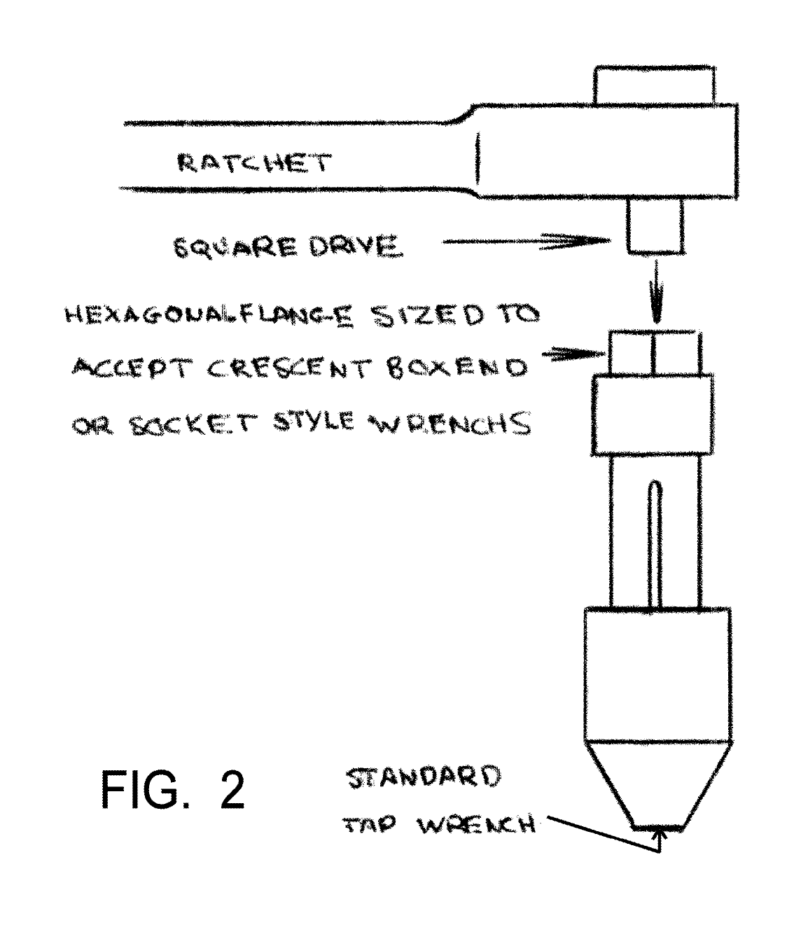

FIG. 2 shows an additional view of the structure shown in FIG. 1.

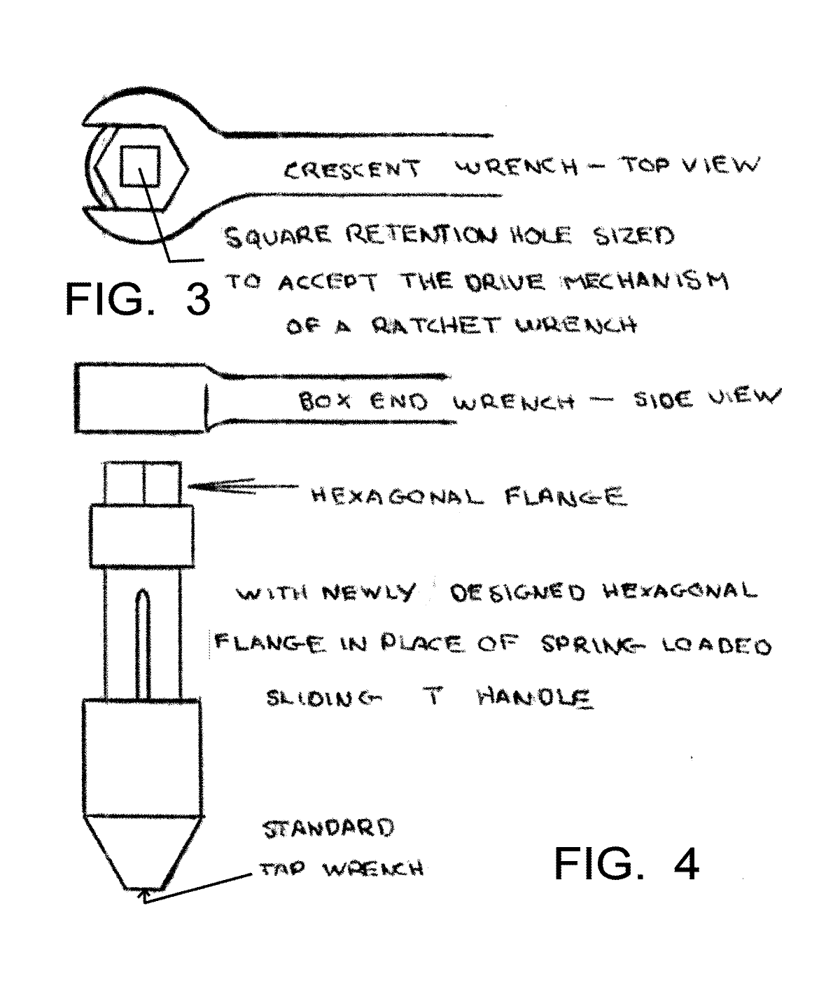

FIG. 3 shows, in top view, how the device shown in FIG. 1 can be driven by a crescent wrench. The crescent wrench engages the hexagonal projection as shown best at the top of FIG. 3. In use, the crescent wrench would be pressed a downward onto the flange to allow pressure to be placed on the tap by the wrench.

FIG. 4 shows an elevation view of the embodiment shown in FIG. 3.

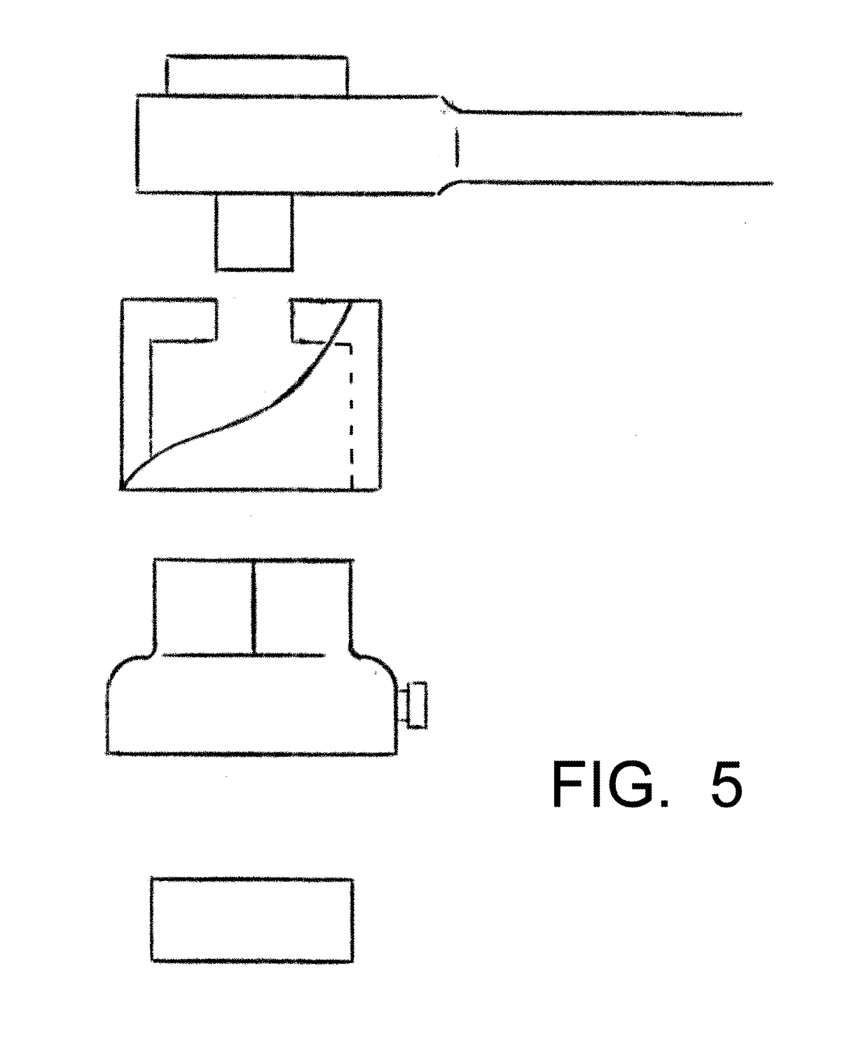

FIG. 5 shows an overall view of a die holder embodying the principles of the present invention. The bottom element is the die. Above that is the die holder, the bottom of which has an opening in which the die can be locked and an upper wrench engageable external projection.

Above that is a conversion socket with a downwardly facing opening capable of engaging the wrench engageable projection and an upper opening capable of being driven by a socket wrench which is shown at the top of the FIG. 5.

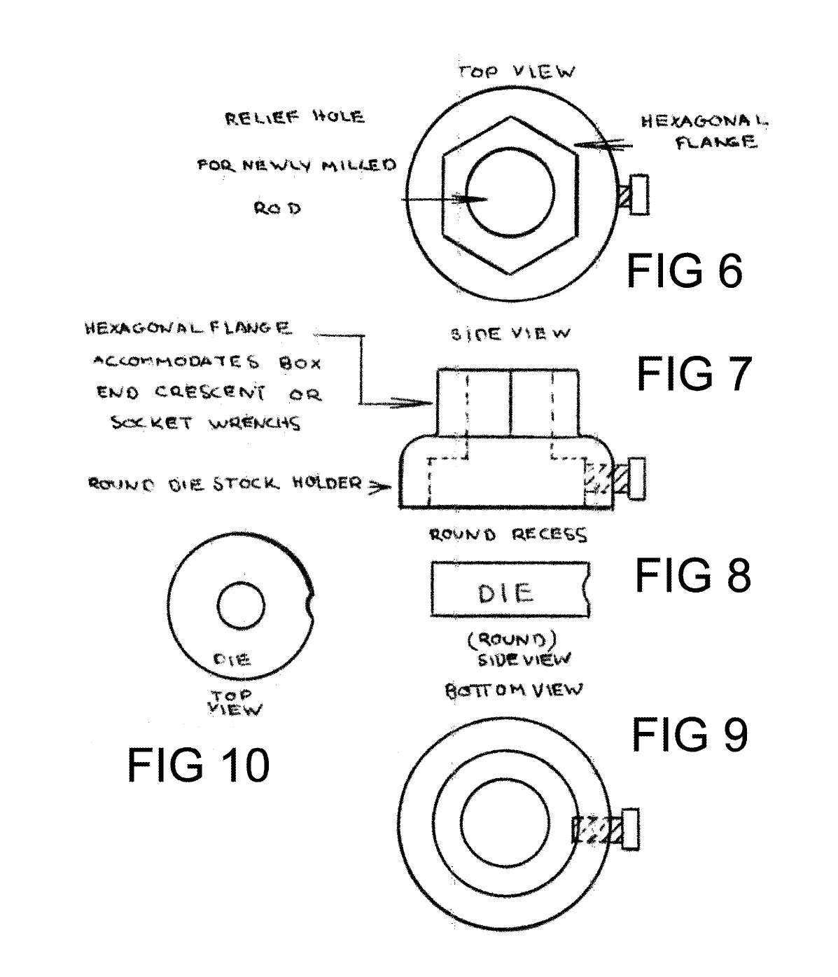

FIG. 6 shows a top view of a die holder especially useful for putting threads on a long shaft. FIG. 9 is a bottom view of the die holder with a holding screw. FIG. 8 is a side view of the die. FIG. 7 is a side view of the die holder. FIG. 6 is a top view of the die holder showing the central round opening sized so that a shaft that is being threaded by the die can extend outward through the die holder, allowing the die in the die holder to put a thread on a very long shaft. FIG. 10 is a top view of the die.

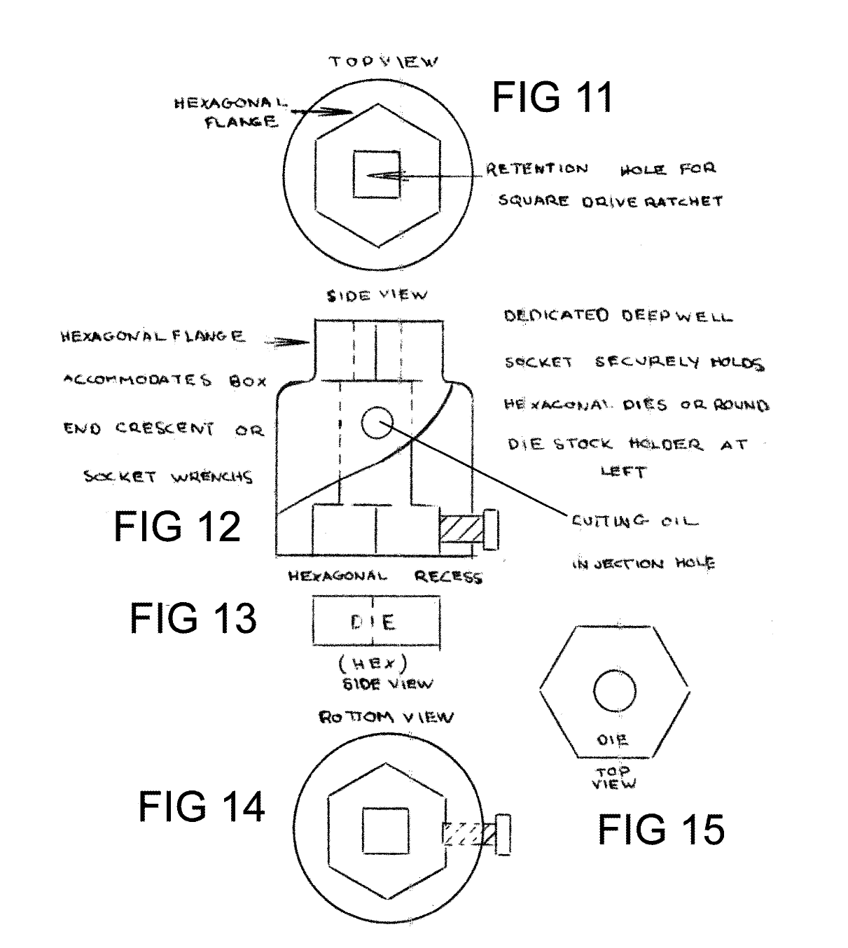

FIG. 11 shows a top view of a version of the die holder specially designed to be driven by either a crescent wrench or a socket drive, and in this instance, intended to drive the hexagonal die. FIG. 14 is a bottom view of the die holder showing that hexagonal opening in which the die is placed and then fastened by the screw.

FIG. 13 is a side view of the hexagonal die and FIG. 15 is a top view of the hexagonal die.

FIG. 12 is the side view of the die holder, with a cutting oil injection hole on the side. FIG. 11 is a top view of the die holder showing the hexagonal wrench engageable external surface and also showing the square hole for the socket drive.

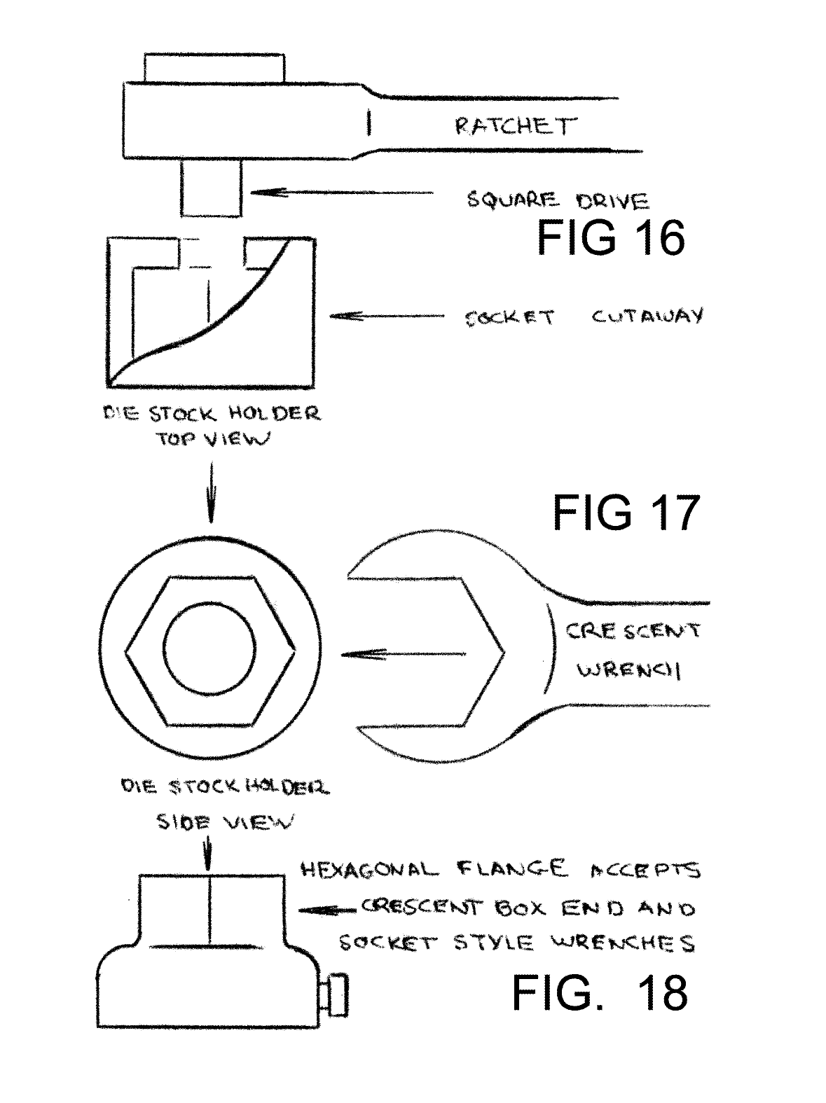

FIGS. 16-18 show additional versions of the concept shown in FIG. 11-15. FIG. 18 is a side view of the die holder with the wrench engageable hexagonal projection on the top. FIG. 17 is a top view of the die holder showing the hexagonal projection that is capable of being driven by a crescent wrench. It also shows the opening through the die holder that allows the shaft being threaded to pass through the die holder. FIG. 16 shows a converter that fits over the hexagonal projection and has a ratchet wrench engageable square bore on top so that the device can be converted to be driven by the socket wrench.

WRENCH-BASED DIE HOLDERS: One embodiment of this invention is a die holder for holding dies used to put threads on or repair threads on shafts, while the die is being used. The die holder is set up with a wrench-engageable end which allows the die holder to be driven by a fixed or adjustable wrench or ratchet wrench.

The original version of this concept is shown in FIGS. 19 through 29. FIGS. 22 and 26 show a typical die which can have a circular circumference as shown in FIG. 22, or a hexagonal circumference as shown in FIG. 26.

The die holder for circular dies is shown in FIGS. 23 through 25, with FIG. 24 showing the elevation view of the die holder, including its wrench-engageable element at the bottom, a plan view shown in FIG. 23, showing the circular opening in which the circular die is held, and a bottom view shown in FIG. 25 showing the hexagonal wrench-engageable element.

The die holder for hexagonal dies is shown in FIGS. 27 through 29, with FIG. 28 showing the elevation view of the die holder including its wrench-engageable element at the bottom, a plan view shown in FIG. 27, showing the hexagonal opening in which the hexagonal die is held, and a bottom view shown in FIG. 29 showing the hexagonal wrench-engageable element.

A feature of this system is shown in FIGS. 19 through 21 which is essentially an elongated, deep-well socket version of the die holder shown in FIGS. 27 through 29 for hexagonal dies.

FIG. 19 is a top view of the elongated die holder, FIG. 20 is an elevation view of the elongated die holder, and FIG. 21 is a bottom view of the elongated die holder.

This elongated die holder is capable of holding a hexagonal die in the opening in its upper end, since that opening is a hexagonal concavity. However, both the hexagonal die holder and the circular die holder can also be held in the opening in the upper end of the elongated die holder, since the wrench-engageable ends of both of the die holder's are the right size to be held by the hexagonal opening in the elongated die holder. This essentially allows the elongated die holder to act as a wrench extension with a wrench driving the lower end of the elongated die holder and the regular die holder and the die (circular or hexagonal) being held at the upper end. This also allows an elongated workpiece to pass through the die and extend deep into the elongated die holder. This allows a long length of thread to formed or repaired on a shaft.

There are various kinds of wrenches including nonadjustable, adjustable, and ratchet wrenches that can be used to engage the wrench engageable elements.

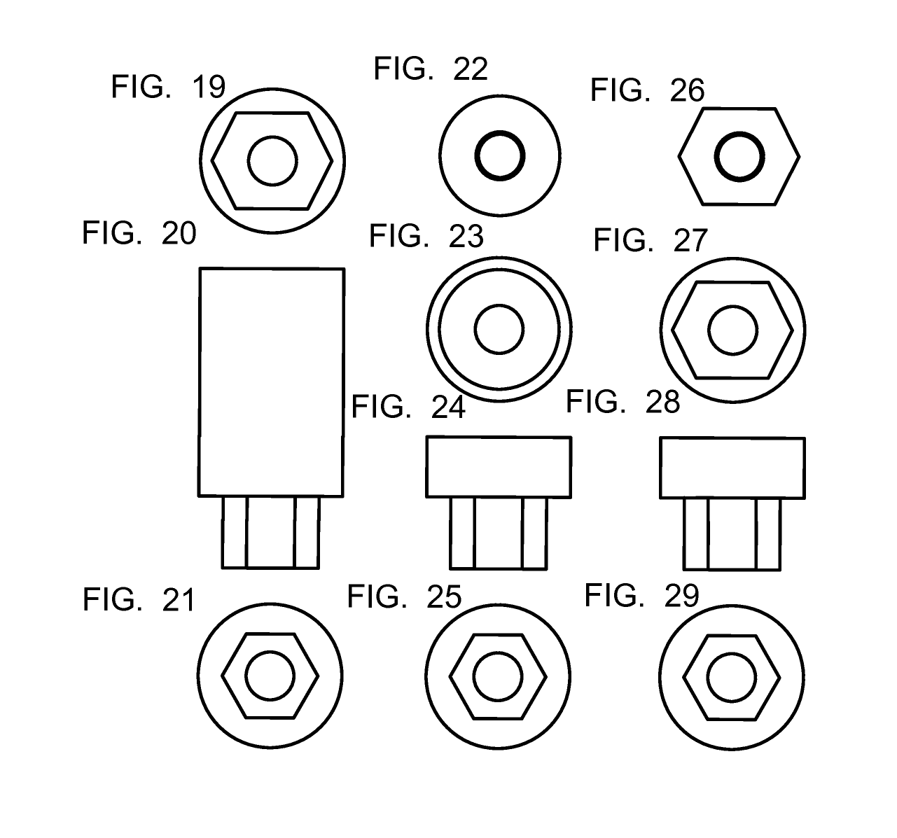

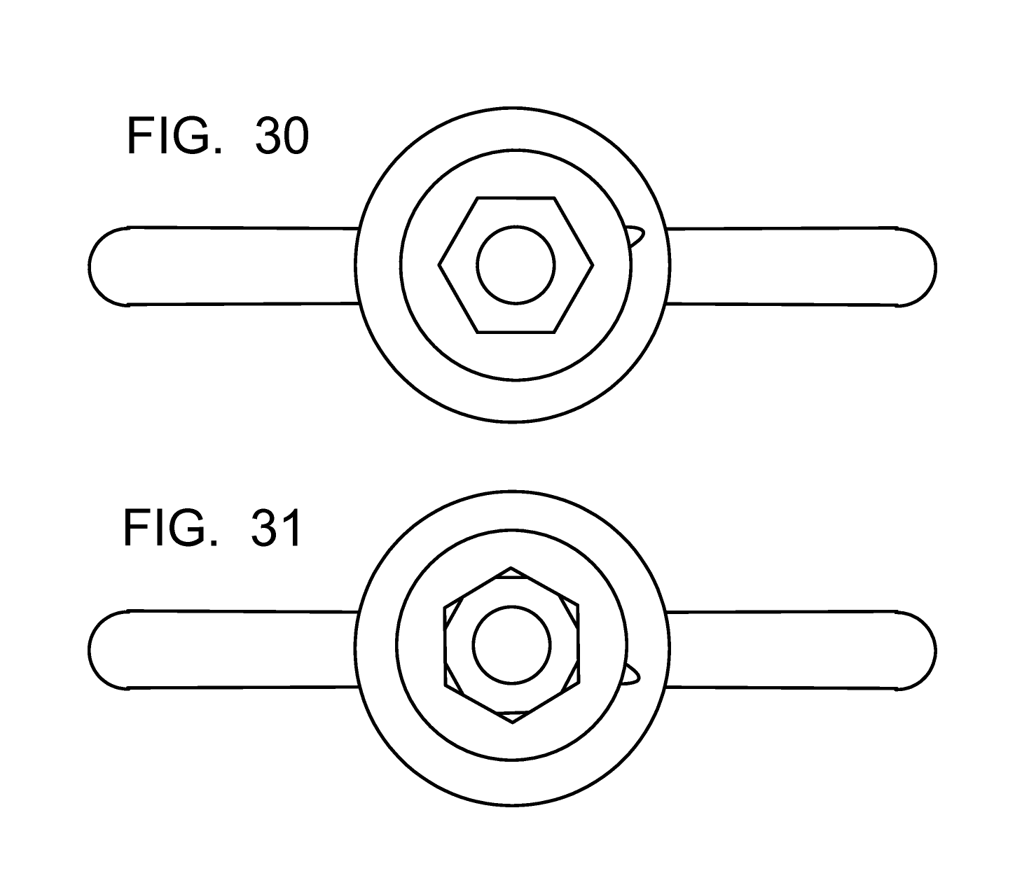

A new kind of wrench has recently been developed and is shown in FIGS. 30 and 31. This wrench has a hexagonal cavity which can hold a hexagonal element. Rotatably mounted on the wrench over the hexagonal cavity is a cap with a hexagonal opening. When the cap is in its unlocking position, the hexagonal opening in the cap and the hexagonal cavity lineup so that a hexagonal wrench-engageable element can be placed into the hexagonal cavity.

When the cap is rotated 30 degrees, the hexagonal opening in the cap is out of alignment with the hexagonal opening and stops hexagonal elements from getting into or out of the hexagonal opening.

This wrench provides a very elegant solution to the problem of holding a hexagonal element in the hexagonal cavity. The problem is that it does not work with the die holders shown in FIGS. 19 through 9, because the rotation of the cap is blocked by the facets on the wrench-engageable elements, at the level of the cap.

One embodiment of invention essentially involves a solution to that problem, by cutting a groove in the wrench-engageable elements of the die holders so that, if the lower end of the die holders is placed in the hexagonal opening and cavity of the wrench, the cap can still be rotated to lock the die holder in the wrench, and stop it from being removed.

FIGS. 32 through 42 show the manner in which this groove is positioned to achieve this benefit.

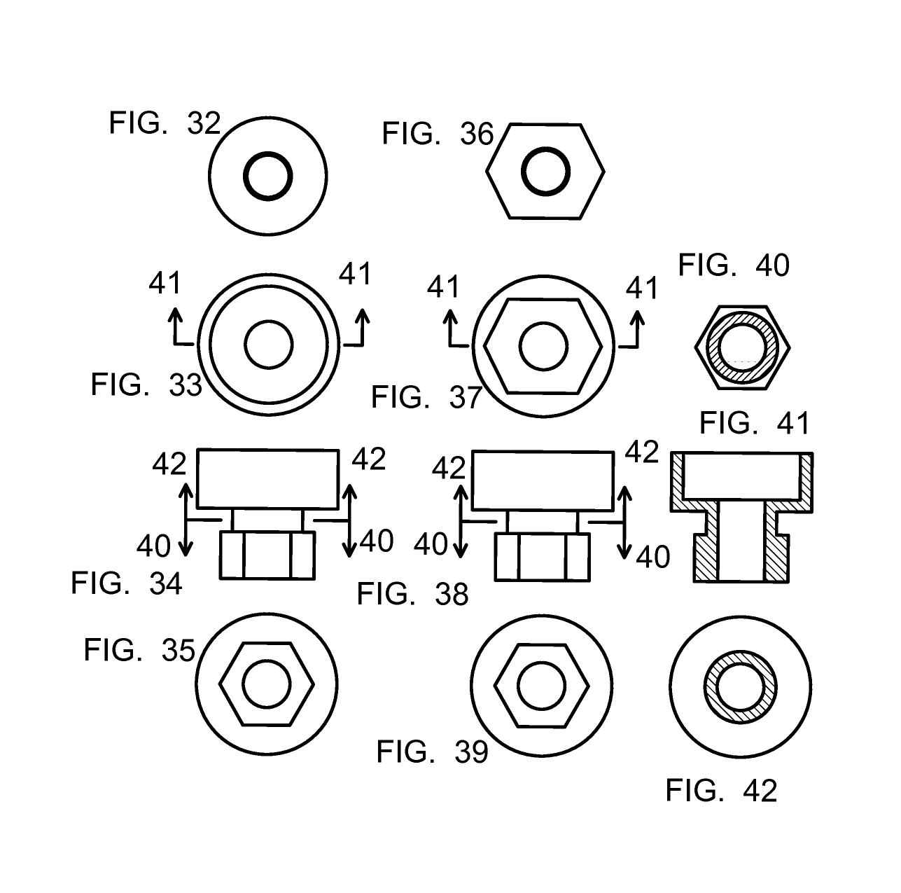

FIGS. 33 through 35 show a die holder for a circular die as shown in FIG. 32. FIG. 34 shows the elevation view, FIG. 33 shows a top view, and FIG. 35 shows the bottom view. The groove is shown in the central portion of the elevation view of the die holder in FIG. 34.

FIGS. 37 through 39 show a die holder for a hexagonal die as shown in FIG. 36. FIG. 38 shows the elevation view, FIG. 37 shows a top view, and FIG. 39 shows the bottom view. The groove is shown in the central portion of the elevation view of the die holder in FIG. 38.

FIG. 40 shows a sectional view taken along line 40-40 of FIG. 34. FIG. 41 shows a sectional view taken along line 41-41 of FIG. 33 and along line 41-41 of FIG. 38. FIG. 42 shows a cross-sectional view taken along line 42-42 of FIG. 34, and along line 42-42 of FIG. 38.

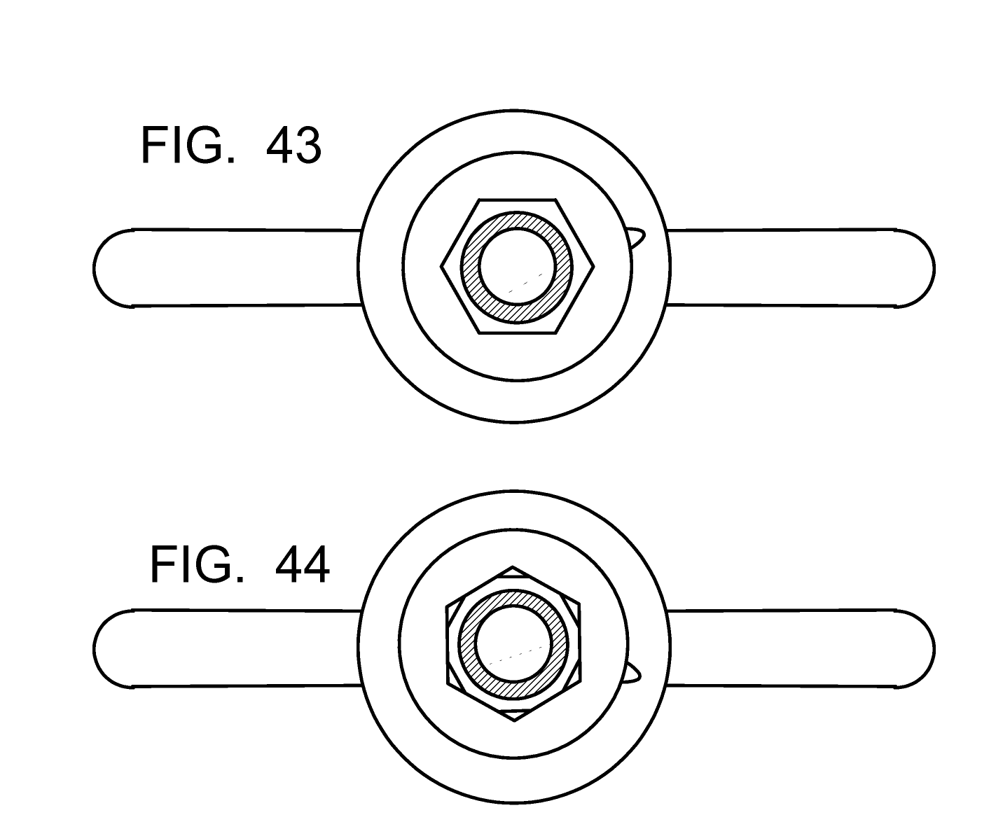

FIGS. 43 and 44 show the two positions of the wrench as it holds the cross-sectional representation of FIG. 40. FIG. 43 shows the unlocked position, and FIG. 44 shows the locked position.

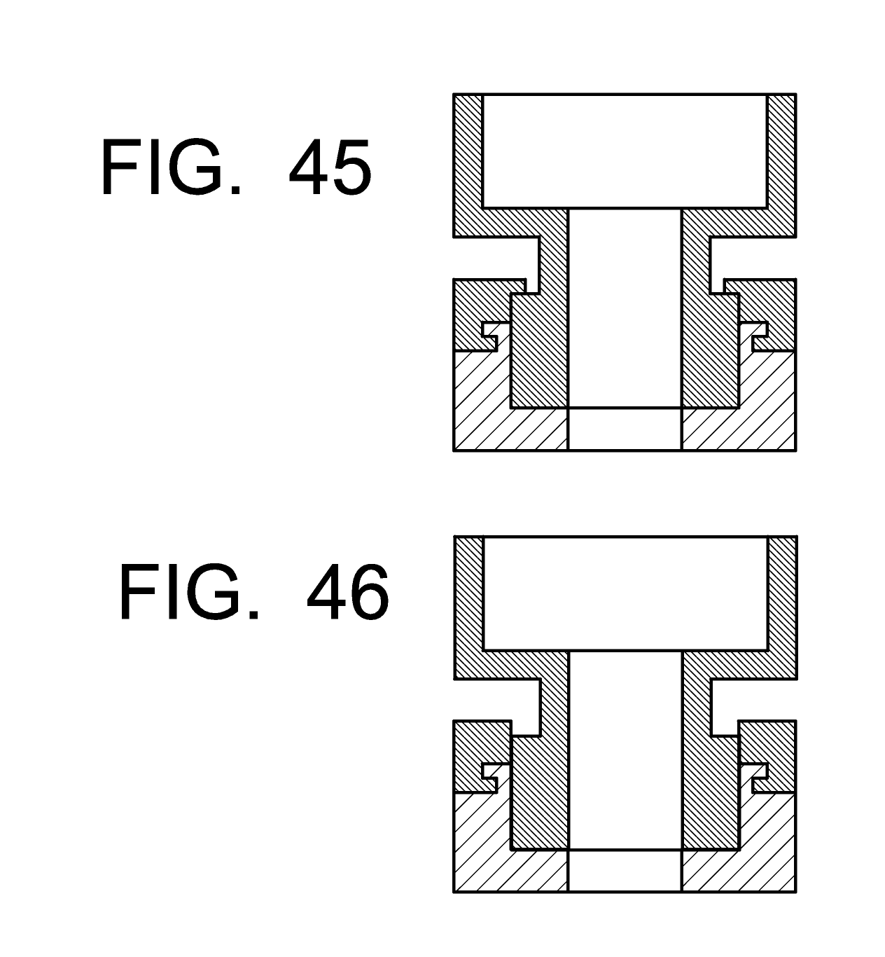

Another way of looking at this is shown in FIGS. 45 and 46. These are cross-sectional views as would be seen in FIG. 41. FIG. 45 shows the wrench engageable element locked in the wrench. FIG. 46 shows the wrenching digital element not locked in the wrench.

For the sake of clarity, the tab on the cap of the wrench is shown to move 30 degrees from the unlocked to the locked position, from FIG. 43 to FIG. 44.

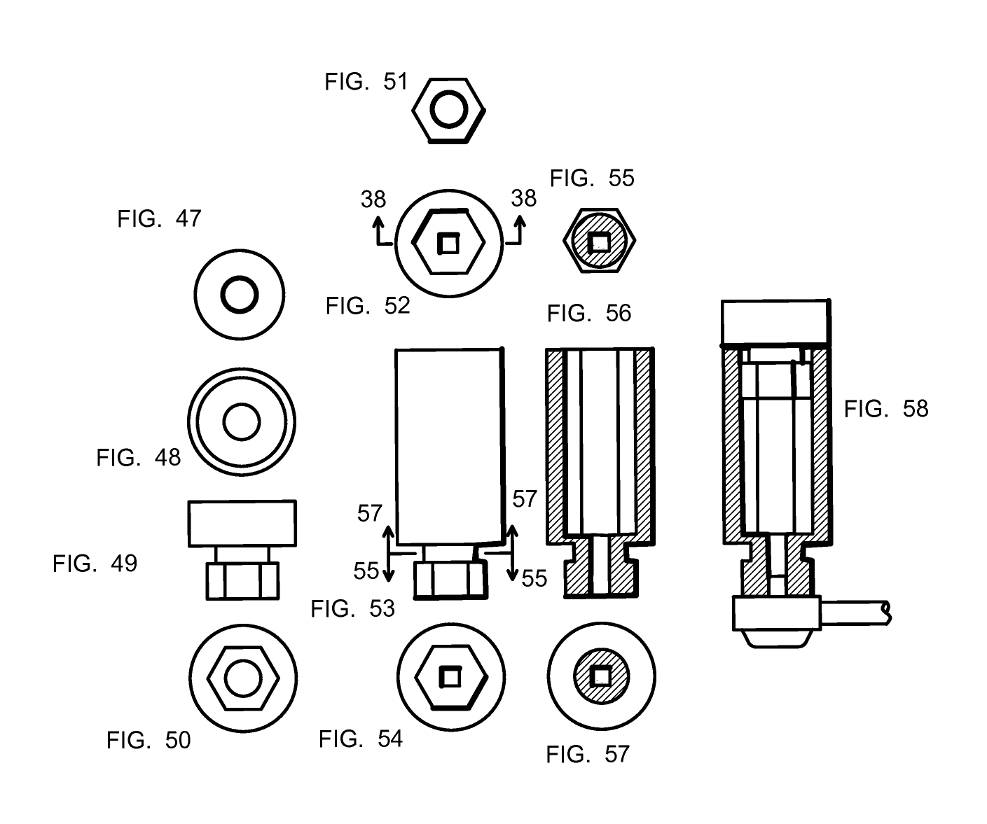

FIGS. 47-60 show a version of this invention in which a combination of elements can provide extreme versatility. This version employs a deep-well socket, like that shown in FIG. 27-29, except that it has a square cavity in the bottom surface, so that the deep-well socket can be driven by a standard ratchet wrench, as shown in FIG. 58. The lower end of deep-well socket can also be driven by other types of wrenches, including the new type of wrench already discussed, because it has the required groove. The hexagonal cavity at the upper end can hold and drive the adapters that, in turn, can hold and drive circular and hexagonal dies. The deep-well socket allows the shaft being threaded to pass through the die and be threaded well along its length. Thus, the deep-well socket with the circular die adapter allows the new wrench discussed above to drive a circular die.

FIG. 47 shows a plan view of a circular die.

FIG. 48 shows a plan view of a circular die holder shown in FIG. 49.

FIG. 49 shows a front elevation view of the circular die holder shown in FIG. 48.

FIG. 50 shows a bottom view of the circular die holder shown in FIG. 49.

FIG. 51 shows a plan view of a hexagonal die.

FIG. 52 shows a plan view of a deep-well socket shown in FIG. 53.

FIG. 53 shows a front elevation view of the deep-well socket shown in FIG. 52.

FIG. 54 shows a bottom view of the deep-well socket shown in FIG. 53.

FIG. 55 shows a plan view, in section as viewed along the line 55-55 of the deep-well socket shown in FIG. 53.

FIG. 56 shows a front elevation view, in section as viewed along the line 56-56 of the deep-well socket shown in FIG. 52.

FIG. 57 shows a bottom view, in section as viewed along the line 57-57 of the deep-well socket shown in FIG. 53.

FIG. 58 shows a front elevation view, in section as viewed along the line 56-56 of the deep-well socket shown in FIG. 52, with the round die holder shown in FIG. 52, held in its upper cavity, and a standard socket wrench inserted in the cavity in the bottom end.

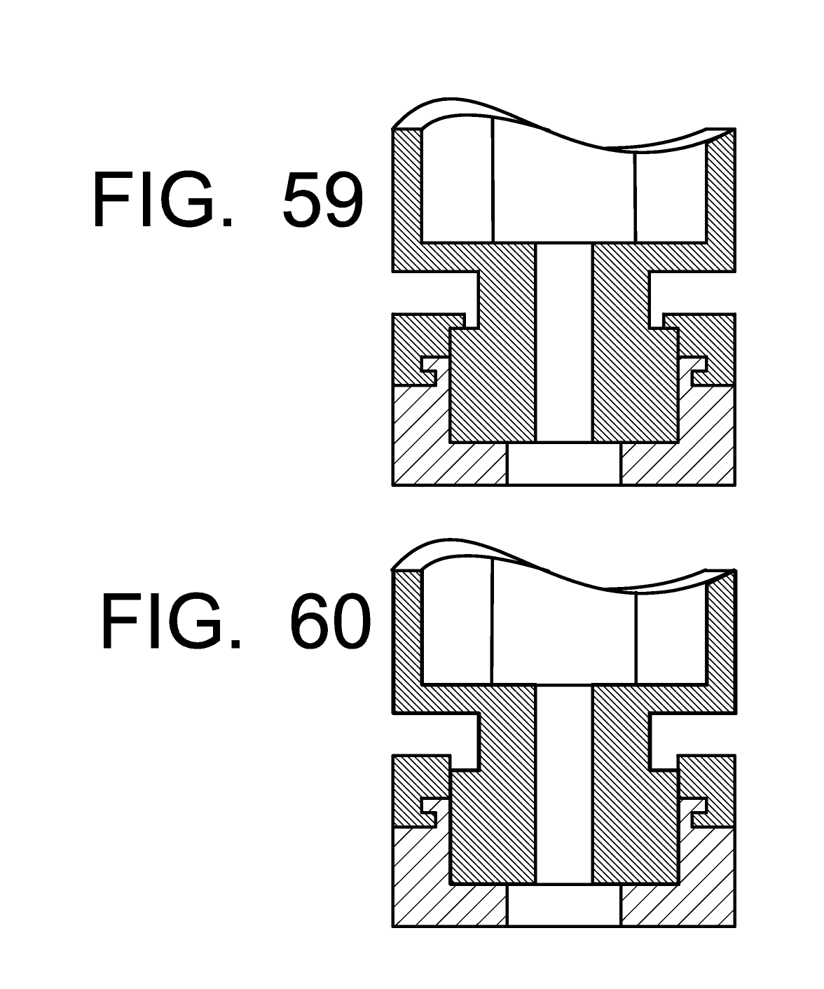

FIG. 59 shows one of two positions of the new wrench as it holds the cross-sectional representation of the wrench-engagable element of the deep-well socket of FIG. 56. FIG. 59 shows the locked position.

FIG. 60 shows one of two positions of the new wrench as it holds the cross-sectional representation of the wrench engagable element of the deep-well socket of FIG. 56. FIG. 60 shows the unlocked position.

Another optional aspect of the present invention is the concept of a non-rotatable collet.

In a conventional tap holder, the chuck is surrounded by a collet, which is threadedly engaged to the shank of the chuck. As the collet it is rotated about the axis of the shank, the jaws of the chuck are drawn together, and if a tap is present between the jaws, the tap is held in the chuck as the collet is rotated and drawn upward on the threads.

A drawback of this construction is that the collet is rotatable about the axis of the shank and therefore cannot practically be used as a wrenching engaging element for driving the shank at its position close to the tap. There are circumstances in which it would be advantageous to allow a wrench to engage the collet end of the shank, close to the workpiece.

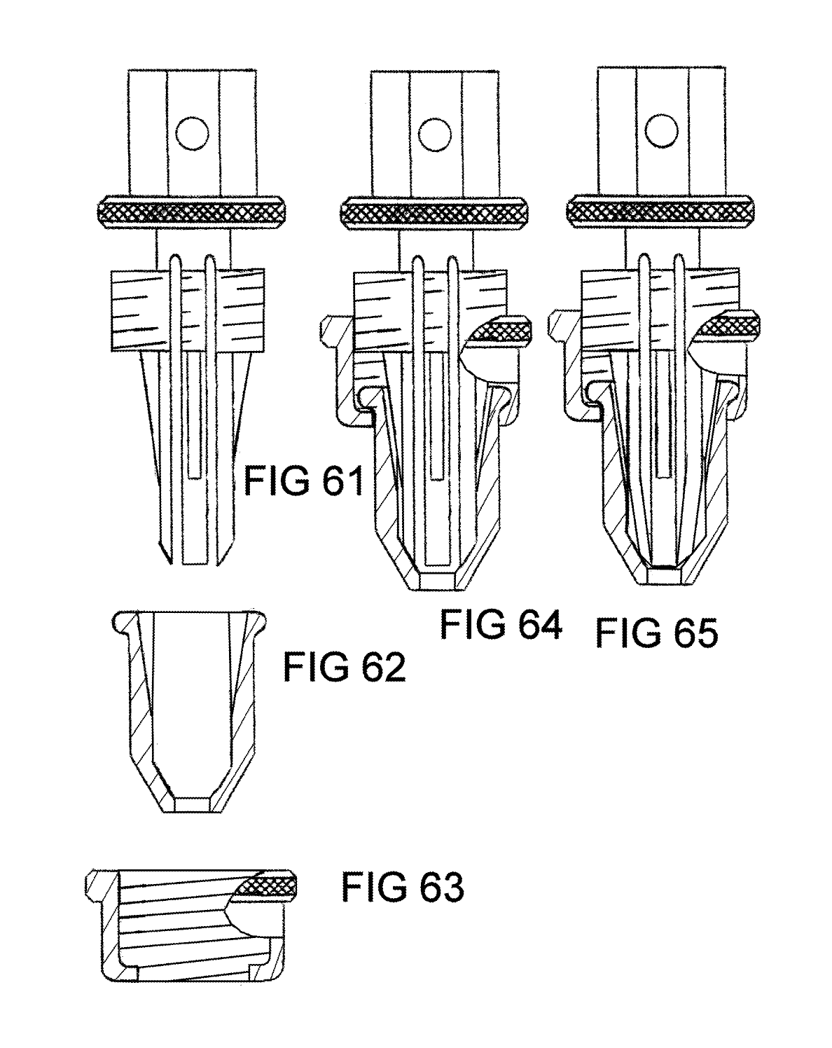

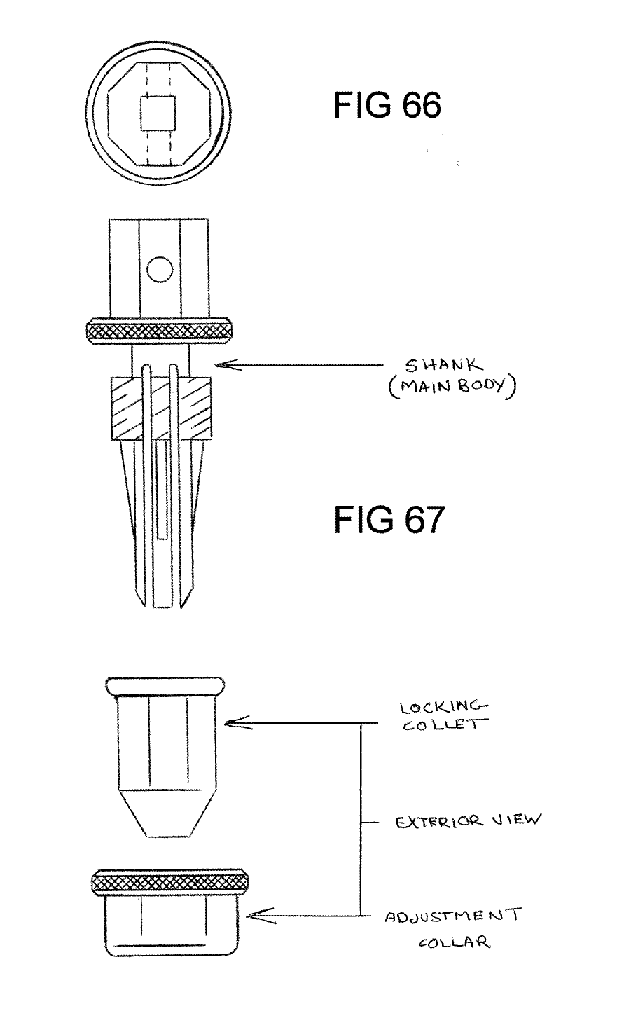

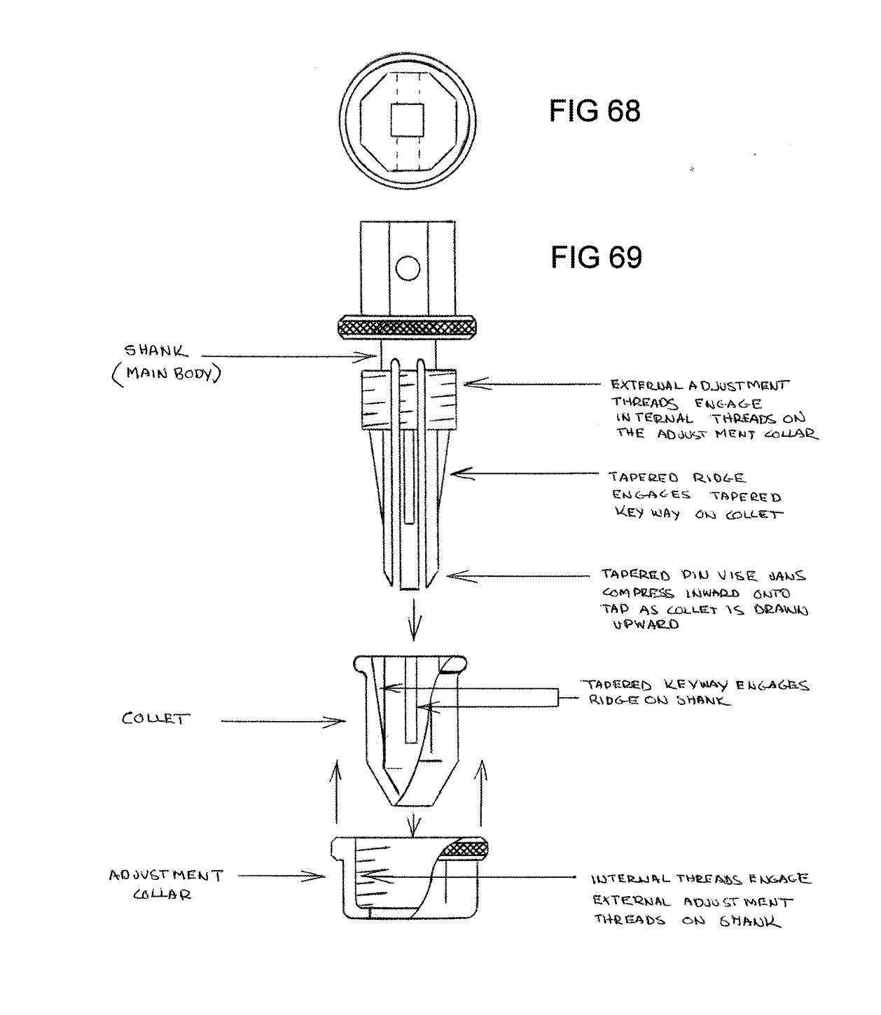

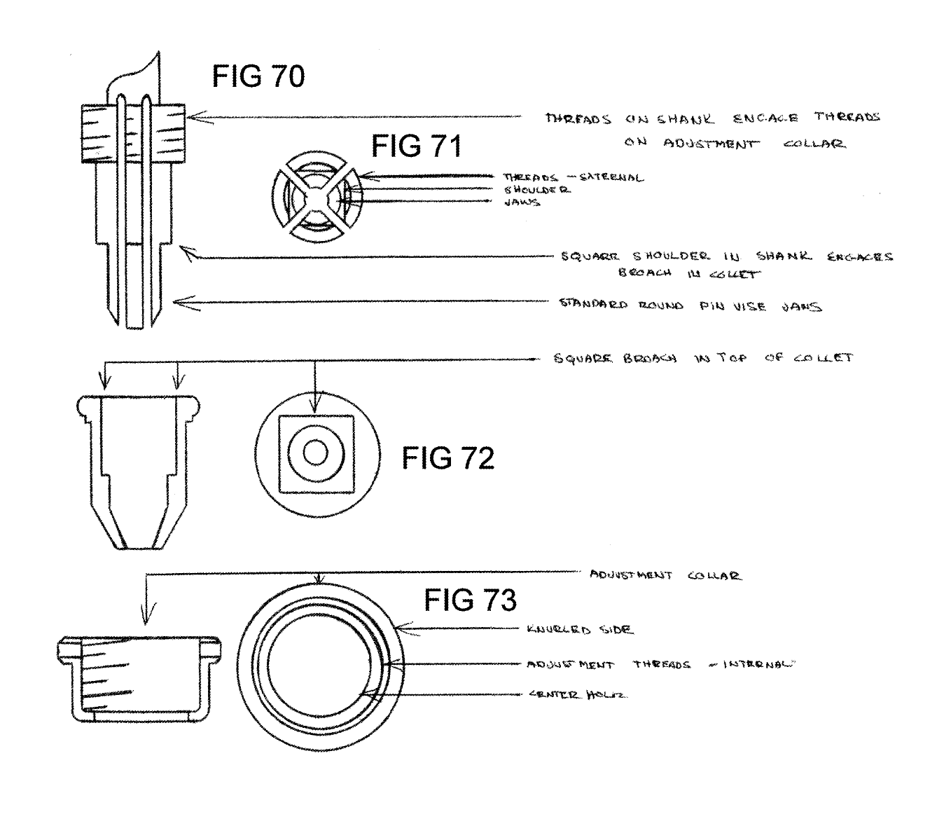

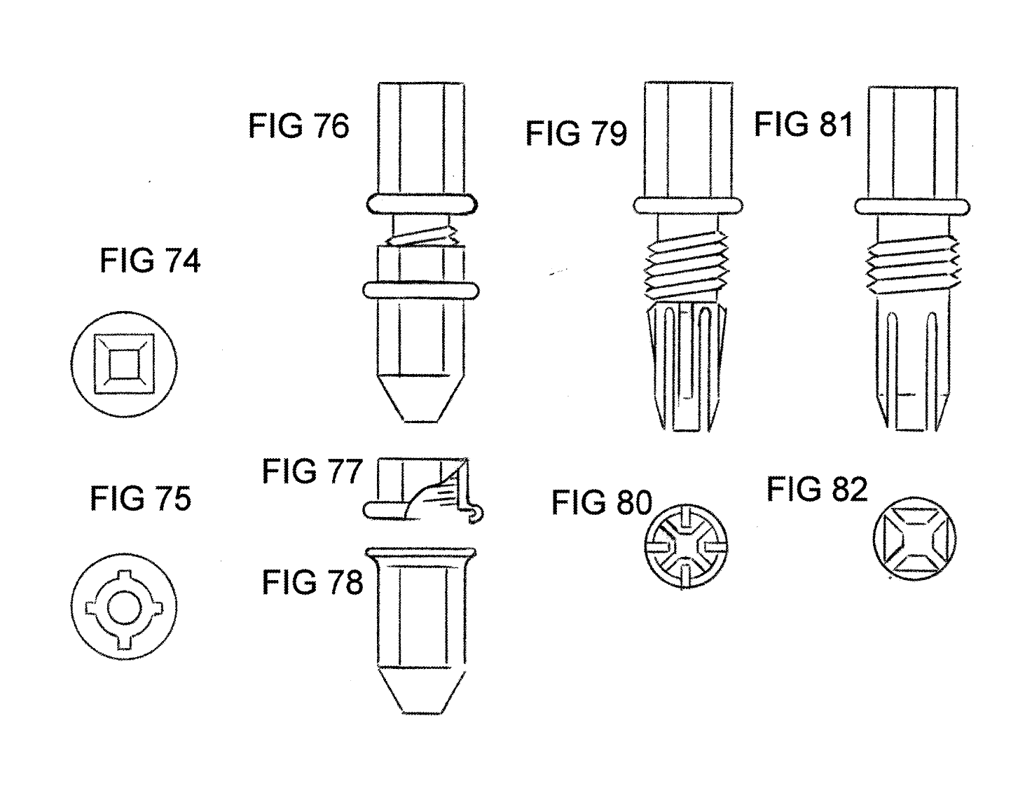

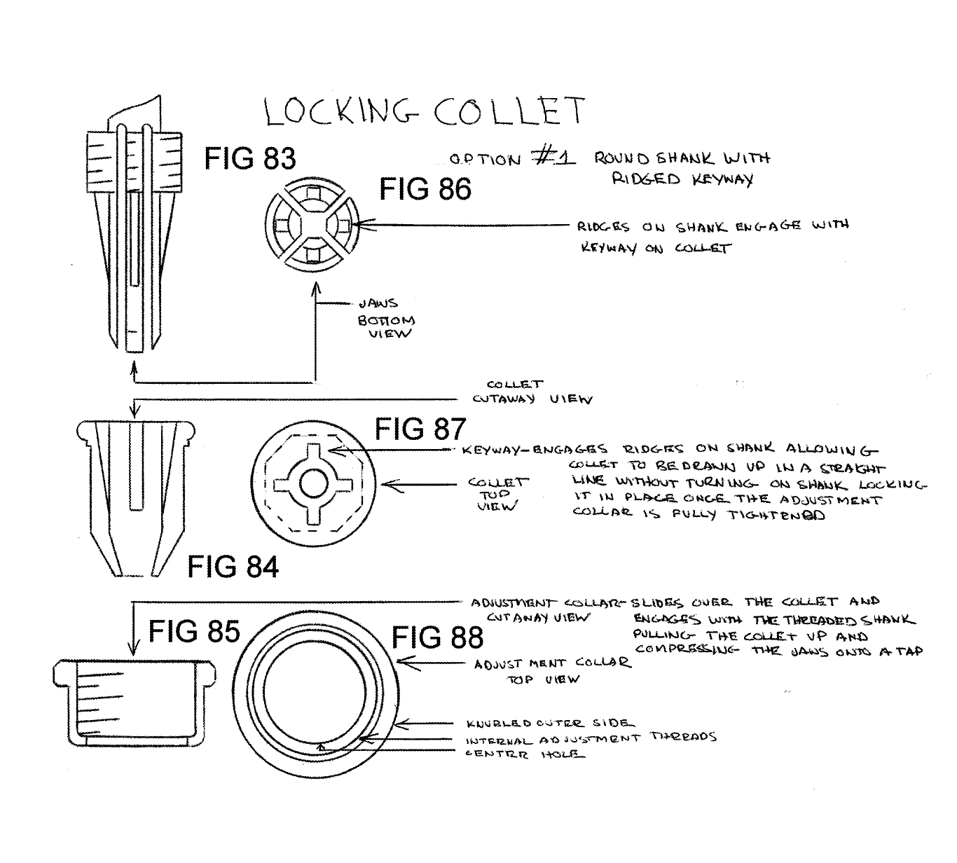

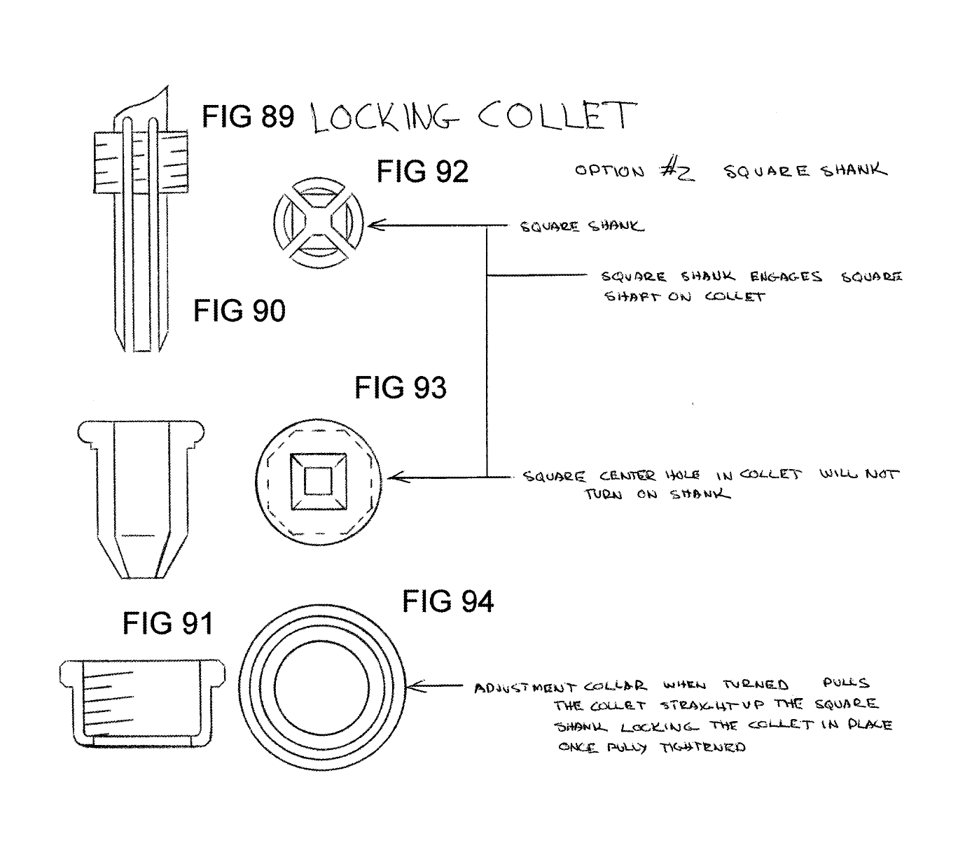

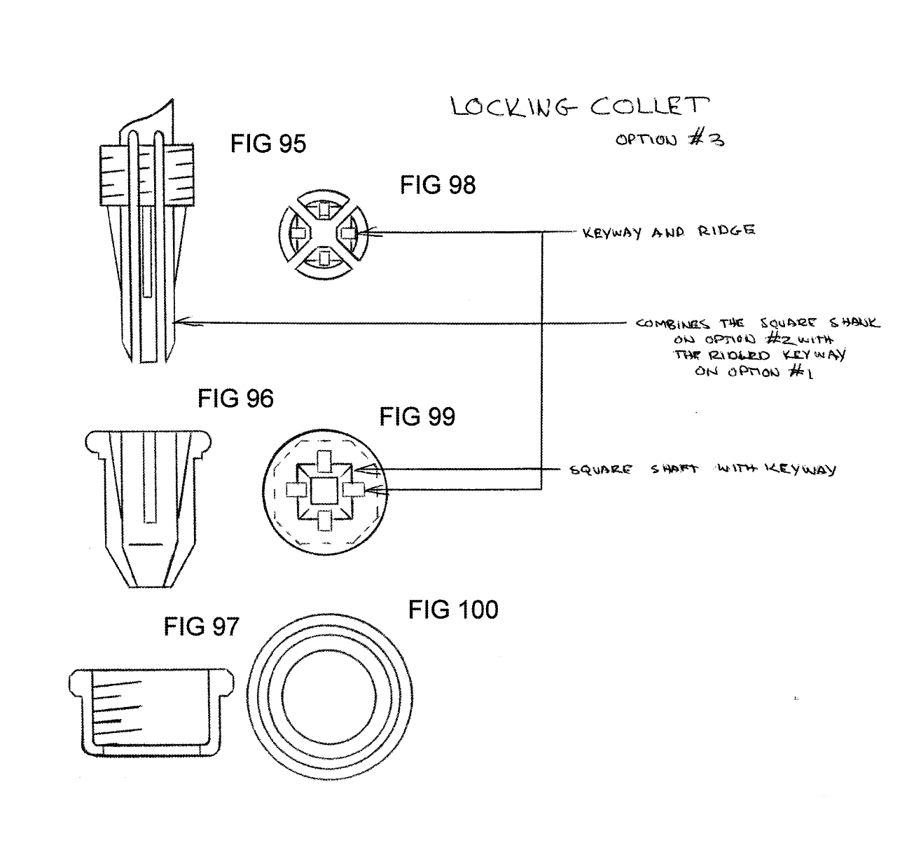

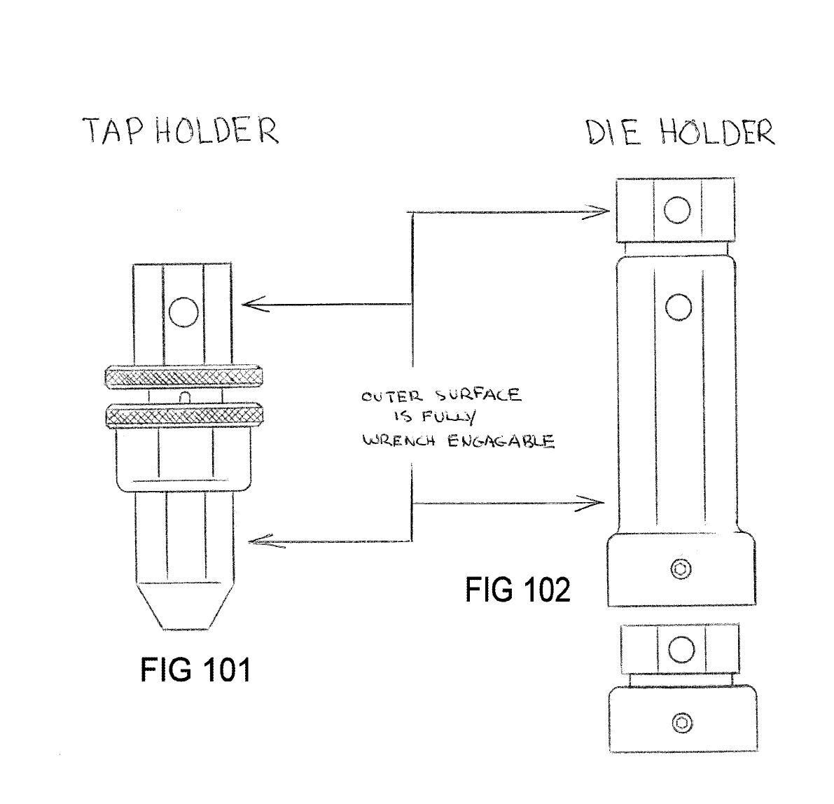

As shown in FIGS. 61-65, this non-rotatable collet concept places anti-rotation pairs, such as lands and grooves on the outside of the shank and on the inside of the collet, so that the collet cannot rotate about the axis of the tap holder and with respect to the shank, but the collet can still move longitudinally along the axis of the shank. Also, the collet is not threadedly engaged to the shank of the tap holder, although it still functions to press the jaws of the chuck together. The manner in which this is accomplished is by having the collet surrounded by a collar which is rotatable with respect to the collet, about the axis of the shank, is threadedly engaged to the shank of the holder. Thus, there are threads on a threaded flange on the shank of the holder and corresponding threads on the inside of the collar.

In the embodiment shown in FIG. 62, the upper end of the collet has a peripheral outwardly-directed flange, and, as shown in FIG. 63, the lower end of the collar has peripheral inwardly directed flange. These two flanges engage one another, so that when the collar is driven upward by rotation on the threads of the shank, the collet is drawn upward with it. This upward movement of the collet draws in the jaws of the chuck together without any rotation between the collet and the shank. The result is that the collet can be provided with external facets, so that it is wrench engageable, and, because it does not rotate with respect to the shank, the collet can be driven by a wrench, which in turn drives of the shank, which in turn drives the tap, without tightening or loosening the chuck.

FIG. 64 shows the assembly of the tap holder shank, the collet, and the surrounding collar, engaging the threads of the shank. Similarly, the lands and grooves of the shank and collet are engaged so that the collet cannot rotate with respect to the axis of the shank. In this view, the jaws of the chuck are not yet closed.

In FIG. 65, the collar has been threaded upward on the threaded flange of the shank, thus drawing the collet upward and squeezing the jaws of the chuck together to hold a tap that would be positioned between the jaws of the chuck.

In this position, the external facets on the collet can be driven with a wrench to cause the tap to rotate.

The system may also have a bore through the shank, perpendicular to the axis of the shank, and preferably through the wrench-engageable portion of the shank. A separate shaft can be threaded though the bore to provide a lever to rotate and drive the die shaft.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A threading tool, such as a tap or die holder, configured to be driven by a generic wrench.

2. A tool as recited in claim 1, wherein the tool is provided with a wrench-engageable surface.

3. A tool as recited in claim 2, wherein the tool is provided with a wrench-engageable surface, namely a faceted cylindrical surface

4. A tool as recited in claim 2, wherein the tool is provided with a wrench-engageable surface, namely a cylinder with a polyhedral cross-section perpendicular to its axis.

5. A tool as recited in claim 2, wherein the tool is provided with a wrench-engageable surface, and outwardly extending peripheral flange, downward from the wrench-engageable surface, that contacts and allows an open-backed wrench to exert downward force on the tool.

6. A tool as recited in claim 2, wherein the tool is provided with a wrench-engageable surface, and an inwardly extending peripheral groove, downward from the wrench-engageable surface, that allows a wrench to insert a holding device into the profile of the tool to hold the wrench and tool together.

7. A threading holder comprising:
a. a shank having an axis,
b. a chuck at a first end of the shank, and having a holding function,
c. a collet that activates the holding function by moving along the axis of the shank, and
d. an anti-rotation system that prevents the collet from rotating about the axis of the shank.

8. A threading holder as recited in claim 7, wherein the collet may have a wrench-engageable surface.

9. A threading holder as recited in claim 7, wherein a collar is threaded to the holder, and moves the collet along the axis.
